(19) United States
(12) Patent Application Publication
(10) Pub. No.: US 2009/0212913 A1
(43) Pub. Date: Aug. 27, 2009

(54) Radio Frequency Identification Enabled Tag And Method For Its Production

(75) Inventors: Adam Barksdale, Kansas City, MO (US); Jim Stradinger, Overland Park, KS (US)

Correspondence Address: LATHROP & GAGE LLP, 2345 GRAND Boulevard, SUITE 2400, KANSAS CITY, MO, 64108, US

(73) Assignee: Holland1916 Inc

(21) Appl. No.: 12/034,786

(22) Filed: Feb. 21, 2008

(51) Int. Cl. H04Q 5/22

(52) U.S. Cl. 340/10.1

(57) ABSTRACT

An apparatus and method for radio frequency identification (RFID) tags provides RFID enabled metal tags that are of thicknesses limited only by the thickness of the RFID chip embedded therein. The metal can support variable information, and as such, may be printed economically in short runs by various metal printing techniques. The RFID chip in the tag is readable from two sides of the tag.

### TECHNICAL FIELD

The disclosed subject matter is directed to Radio Frequency Identification (RFID), and in particular to tags with RFID chips, and methods for making these tags.

### BACKGROUND

Radio Frequency Identification (RFID) is a technology that incorporates the use of electromagnetic or electrostatic coupling in the radio frequency (RF) portion of the electromagnetic spectrum to uniquely identify an object, animal, or person. RFID is coming into increasing use in industry as an alternative to bar codes. The advantage of RFID is that it does not require direct contact or line-of-sight scanning. An RFID system consists of three components: an antenna and transceiver (often combined into one reader) and a transponder (the tag or chip). The antenna uses radio frequency waves to transmit a signal that activates the transponder. When activated, the tag or chip transmits data back to the antenna. The data is used to notify a programmable logic controller of an identification or that an action should occur.

Low-frequency RFID systems (30 KHz to 500 KHz) have short transmission ranges (generally less than six feet). High-frequency RFID systems (850 MHz to 950 MHz and 2.4 GHz to 2.5 GHz) offer longer transmission ranges (more than 90 feet). In general, the higher the frequency, the more expensive the system.

Sling identification tags, also known as sling tags, are tags that are permanently affixed to slings, loops of material, such as chains, wire rope and wire mesh, that connect loads to lifting devices. The sling tag is required by ASME (American Society of Mechanical Engineers) B30.9 2006 and includes indicia indicating the size, grade, rated capacity and reach of the sling. Similarly, other identification tags are commonly used in numerous applications, such as placement on computers, appliances and the like. However, development of metal sling tags and other metal identification tags that used RFID has been slow.

One presently available RFID enabled metal sling tag is from the Crosby Group Inc. of Tulsa Okla., as part of their QUIC-CHECK® Inspection and Identification System. These QUIC-CHECK® enabled metal tags are of a cast stainless steel and include an indented space in the tag for mounting an RFID chip. As a result of this indented space, the RFID chip is positioned in the tag such that it is open and exposed on only one side of the tag. The RFID chip rests within the indented space surrounded on one side and along its periphery by insulating spacers, to prevent chip to metal contacts, to avoid radio frequency interference.

This structure presents drawbacks, as the RFID chip is only readable from one side of the tag, where it is open and exposed, as it is surrounded by metal on all other sides of the tag, the metal causing interference with the radio frequency waves, needed to read the chip. By being readable on only one side of the RFID chip, the RFID chip is not fully utilized, and not all desired information may be placeable on the RFID chip. Because these QUIC-CHECK® tags are cast, they are of thicknesses greater than the RFID chip, and their uses are limited, as due to their thickness, they are not usable for marking numerous articles. Moreover, these cast tags can not support variable information, other than being recast, an expensive process requiring new molds and tools every time there is a change in the information, or completely new information.

### SUMMARY

The apparatus and method of the disclosed subject matter are directed to RFID enabled metal tags that are of thicknesses limited only by the thickness of the RFID chip embedded therein. Accordingly, sheet metal may be used as the tag. This sheet metal can support variable information, and as such, may be printed economically in short runs by various metal printing techniques. The RFID chip in the tag is readable from two sides of the tag. The RFID chip is mounted in resin in an opening in the tag, the opening being of a shape with substantial surface area for creating a strong bond with the resin. Based on the method of manufacturing, insulating spacers are not needed between the RFID chip and the metal of the tag opening, as the spacing function is provided by the resin itself.

An embodiment of the disclosed subject matter is directed to an identification tag. The tag includes a metal body including oppositely disposed first and second sides and an aperture in the body, extending through the body, the aperture including at least one inner edge. A device, that is responsive to electronic signals, for example radio frequency signals or radio waves, is positioned in the aperture by an adhesive material that fixes the device in position in the aperture and maintains the device from contacting the at least one inner edge of the aperture. The device is accessible to electronic signals on the oppositely disposed first and second sides of the body. Additionally, the thickness of the device corresponds substantially to the thickness of the metal body. The device may be, for example, a radio frequency identification (RFID) chip. The adhesive material may be any material that allows for the passage of electronic signals, such as radio waves and signals to pass through it, and may be for example, a resin.

Another embodiment is directed to a method for making an identification tag. The method includes providing at least one metal body with upper and lower surfaces, and making an aperture in the at least one metal body, the aperture extending through the at least one metal body. A device, responsive to electronic signals, for example, a radio frequency identification chip, is placed within the aperture. The device is maintained in a position where it is generally coplanar with the upper and lower surfaces. The aperture is filled with material that allows for the passage of electronic signals therethrough to fasten the device in place such that the device is out of contact with the edges of the aperture and that the device is accessible to electronic signals on both sides of the at least one metal body.

### BRIEF DESCRIPTION OF THE DRAWINGS

Attention is now directed to the drawings, where like numerals or characters indicate corresponding or like components. In the drawings:

FIG. 1 is a front perspective view of a tag of the disclosed subject matter;

FIG. 2 is rear view of the tag of FIG. 1;

FIG. 3 is a rear view of the tag of FIG. 2 with a cap over a portion of the tag;

FIG. 4 is a diagram showing the tag of FIG. 1 in an exemplary operation;

FIG. 5 is a diagram showing a sheet from which the tags of FIG. 1 are made; and

FIGS. 6A, 6B, 7A, 7B and 8 are diagrams showing processing of the sheet of FIG. 5 to make the tags of FIG. 1.

### DETAILED DESCRIPTION

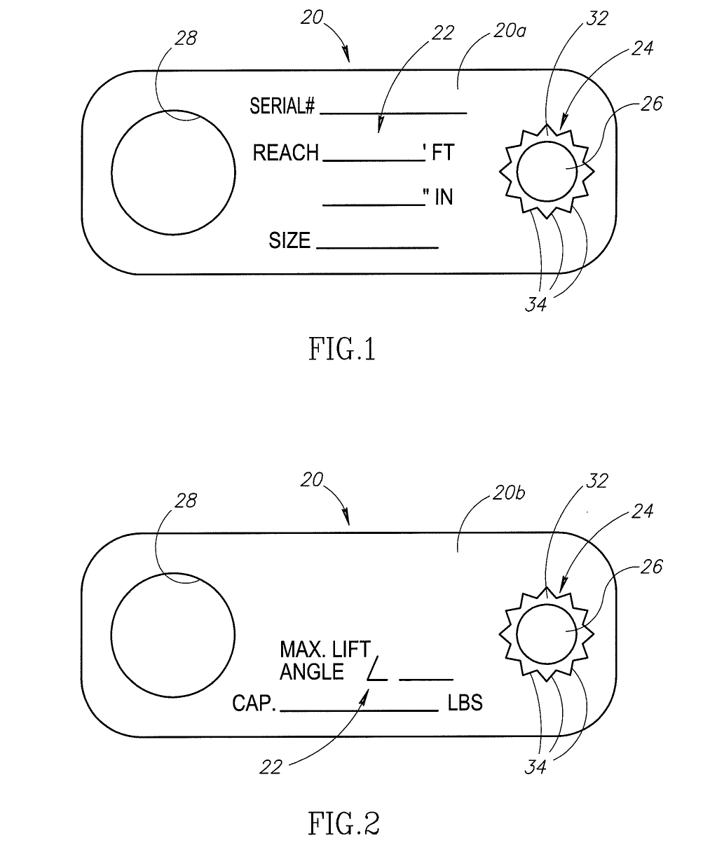

FIGS. 1 and 2 show a tag 20 in accordance with the disclosed subject matter. The tag 20 includes an area for variable information (for example, indicia) 22 and an aperture 24 that supports an RFID chip 26 (for example, a transponder loaded with data including identification data, responsive to radio frequency signals). There may also be other openings 28 in the tag 20. FIG. 1 shows one side 20a of the tag 20, while FIG. 2 shows the opposite side 20b of the tag 20. The tag 20 may be used in numerous applications where identification tags are used, including as a sling identification tag or sling tag.

The RFID chip 26 is held in the aperture 24 (in a fixed position) by adhesive 32, such as a resin or other suitable material, that is electrically nonconductive (insulating or noninsulating), and allows for the passage of electronic (electrical) signals, including radiofrequency signals, radio waves and the like, therethrough. The adhesive 32 also maintains the RFID chip 26 such that the edges of the chip 26 remain out of physical contact from the metal edges 34 of the aperture 24. The aperture 24, is for example, formed of a star shape, such as a twelve pointed star, as the edges 34 that form the star shape provide maximum surface area for the resin 32 to bond. As the aperture 24 is open at both sides 20a, 20b of the tag 20, the RFID chip 26 is accessible from both sides 20a, 20b of the tag 20, free of interference from the metal of the tag 20. While an RFID chip 26 is shown any other device with information responsive to electronic signals is also permissible.

The tag 20 is made of, for example, sheet stainless steel, aluminum or anodized aluminum flat, of thicknesses ranging from, for example, approximately 0.063 inches to 0.125 inches. These metals can be etched or printed on by standard techniques (e.g., screen printing, chemical and laser etching, and the like), in order that variable information may be placed onto the tag 20, in the area 22, on one or both sides 20a, 20b.

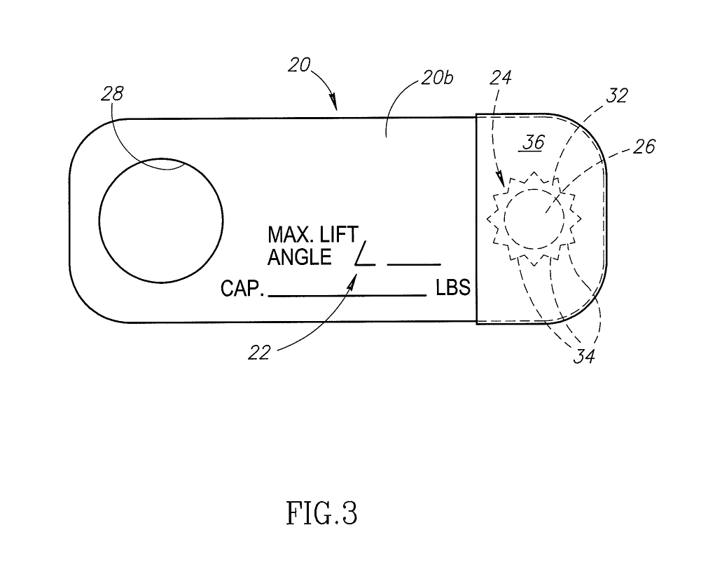

The tag 20 may also include an attachable cap 36, as shown in FIG. 3, to which attention is also directed, that frictionally fits onto the tag 20. The cap 36 protects the RFID chip 26, and can be permanently attached with adhesives or the like to the tag 20. The cap 36 is made of a polymeric material, so as not to create interference with the RFID chip 26.

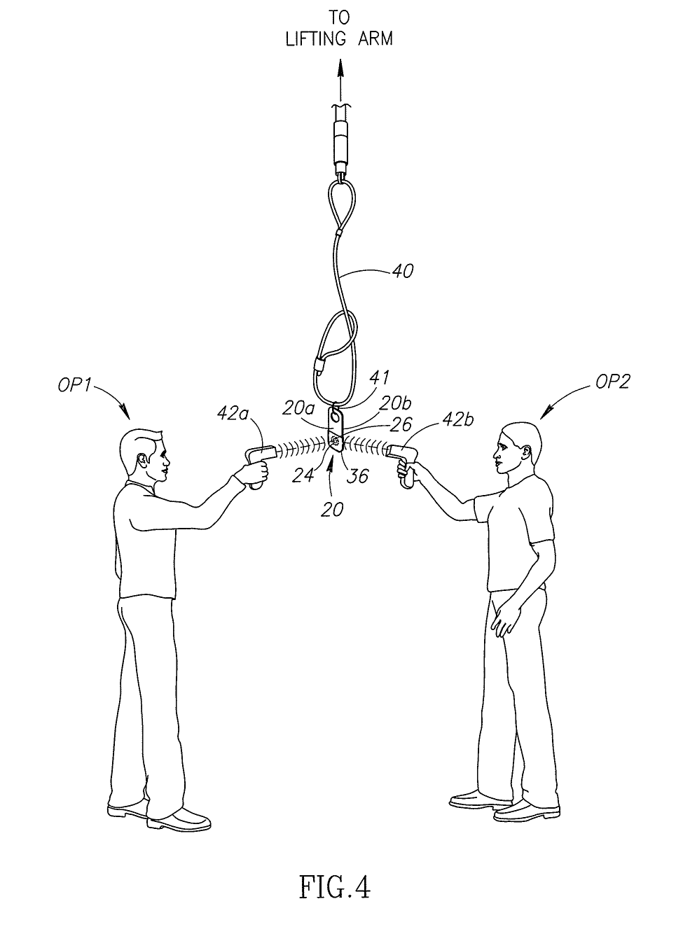

FIG. 4 shows a tag 20 in an exemplary load lifting operation. The tag 20 is attached to a metal wire rope sling 40, as required by U.S. Federal Law, by a wire ring 41. The tag 20, in particular, the RFID chip 26 is accessible from both sides 20a, 20b of the tag 20, free of interference from the metal of the tag 20. Accordingly, a first operator OP1 with a Radiofrequency transceiver (and antenna) unit 42a can access the RFID chip 26 from a first side 20a of the tag 20, while a second operator OP2 with a Radiofrequency transceiver (an antenna) unit 42b can access the RFID chip 26 from a other or second side 20b of the tag 20

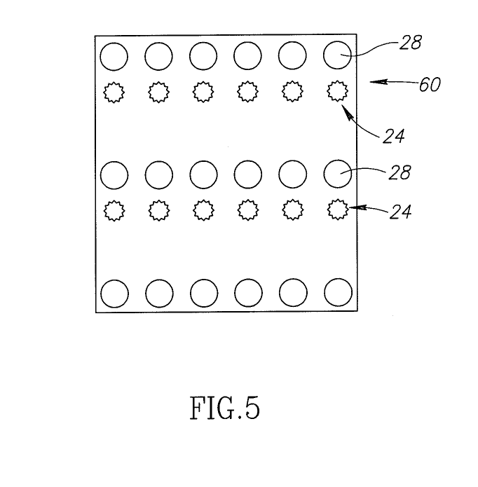

Attention is now directed to FIGS. 5-8 that detail an exemplary process for manufacturing the tag 20. Initially, the process begins with a metal sheet 60, such as a sheet of stainless steel. Variable information may now be placed onto the sheet, at one or both sides, by any of the aforementioned printing and/or etching processes or techniques detailed above. This information is placed in spaces corresponding to the area 22 between the aperture 24 and the opening 28, in a finished tag 20.

In FIG. 5, a star-shaped aperture 24 is punched into the metal sheet 60, and here, for example, another opening 28, proximate to a corresponding star-shaped aperture 24, is punched into the sheet 60. The star shaped aperture 24 is, for example, a twelve pointed star, but stars or shapes of any other arrangements or straight and rounded segments, that provide additional surface area for adhesive bonding, are also suitable, as are completely circular or rounded apertures. The star-shaped apertures 24 and openings 28 are punched, for example, by a press, such as an Amada 33 Ton turret punch press. Variable information may also be placed onto sheet, at one or both sides, at this time, by any of the techniques detailed above. This information is, for example, placed in each space between the aperture 24 and the opening 28, this space corresponding to the area 22 on the finished tag 20.

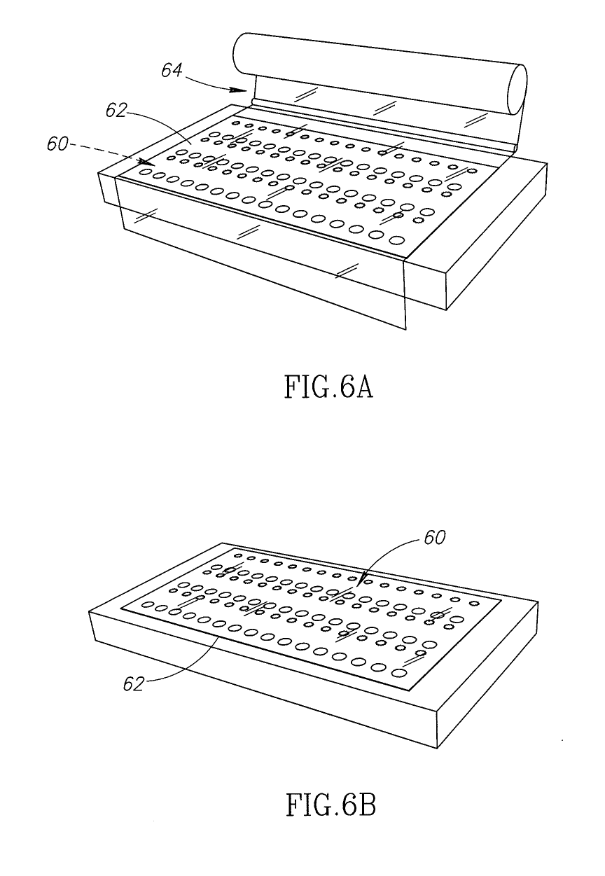

A protective backer or pre-mask 62 is applied to one side of the sheet 60 on a laminating machine 64, as shown in FIG. 6A. The backer 62 serves as a support for the adhesive 32 and the RFID chip 26. The backer 62 also maintains the chip 26 as substantially coplanar with the surface of the sheet 60 (ultimately of the tag 20), serves to keep the adhesive 32 within the plane of the metal of the sheet 60. The now backed sheet 60 is placed onto a work table 66, as shown in FIG. 6B.

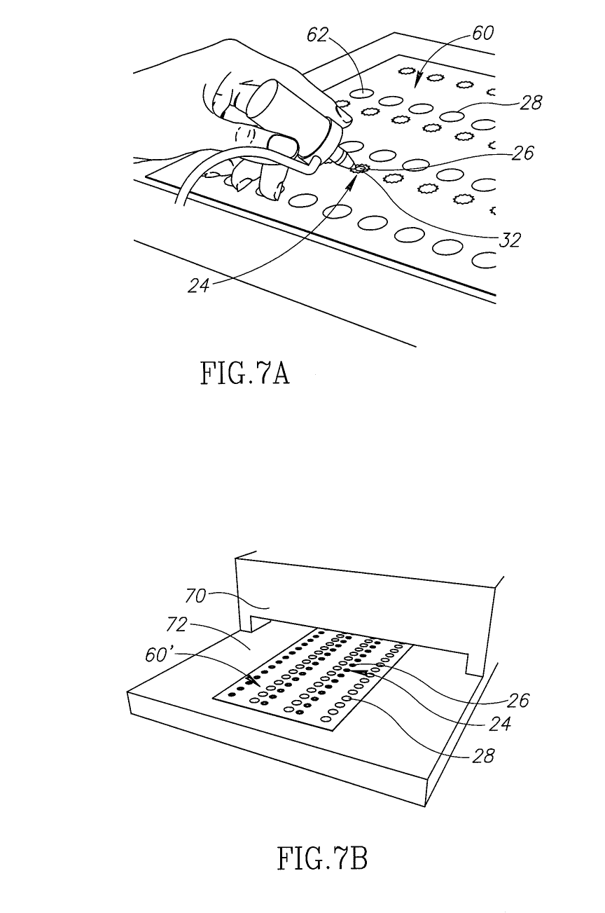

An RFID chip 26 is placed into each aperture 24 of the sheet 60, on the backer 62, spaced apart from the edges 34 of the aperture 24. An adhesive 32, for example, in the form of a resin, is applied over the chip 26 filling the aperture 24, such that there is not any unfilled space between the chip 26 and the edges 34 of the aperture 24, as shown in FIG. 7A. The resin is, for example, a polyurethane resin, such as a Ultra Violet (UV) curable resin. One suitable UV curable resin is Dymax 9-20601.

The resin is cured as the sheet of tags 60′ is moved through a UV dryer 70 on a conveyer 72, as shown in FIG. 7B. Two passes through the dryer 70 are made, one for each side of the sheet 60. Prior to the second pass, the backer or premask 62 is removed. During the passes, dwell times may be less than one minute. The now cured resin is not completely hard, as it has some flexibility.

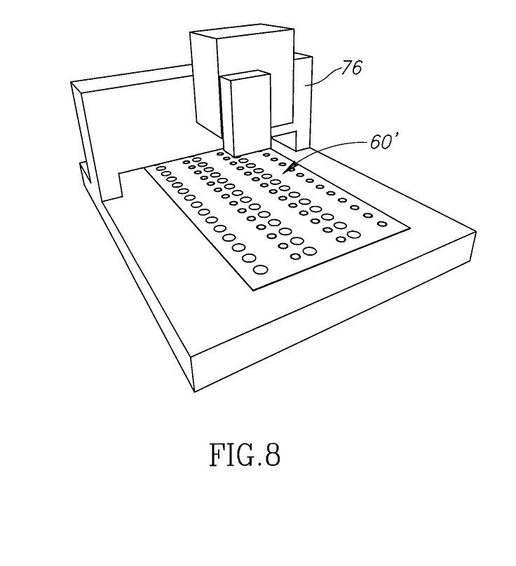

The individual metal tags 20 with the embedded chips 26 are then punched by a press 76 from the sheet 60′, as shown in FIG. 8. The press 76 may be, for example, the aforementioned Amada 33 ton turret punch press. A cap 36 may then be placed onto the tag 20 over the aperture 24 and the RFID chip 26. If desired, the cap 36 may be additionally secured to the tag 20 by adhesives, for example, adhesives free of metal or other materials that may cause interference with electronic signals, including radiofrequency signals, radio waves and the like.

Variable information or additional variable information may now be placed onto sheet, at one or both sides, by any of the printing and/or etching processes or techniques detailed above. This information is placed in each space between the aperture 24 and the opening 28, this space corresponding to the area 22 on the finished tag 20 (that may have been previously etched or printed, as detailed above).

While preferred embodiments of the disclosed subject matter have been described, so as to enable one of skill in the art to practice the disclosed subject matter, the preceding description is intended to be exemplary only. It should not be used to limit the scope of the disclosed subject matter, which should be determined by reference to the following claims.

What is claimed:

1. An identification tag comprising:
a metal body including oppositely disposed first and second sides;
an aperture in the body, extending through the body, the aperture including at least one inner edge; and
a device responsive to electronic signals within the aperture and positioned in the aperture by an adhesive material that fixes the device in position in the aperture and maintains the device from contacting the at least one inner edge of the aperture, the device being accessible to electronic signals on the oppositely disposed first and second sides of the body.

2. The identification tag of claim 1, wherein the metal body includes sheet metal.

3. The identification tag of claim 1, wherein the aperture is of a circular shape and the at least one inner edge includes a single edge.

4. The identification tag of claim 1, wherein the aperture is of a star-like shape and the at least one inner edge includes a plurality of inner edges corresponding to the segments defining the star-like shape.

5. The identification tag of claim 4, wherein the star-like shape includes a twelve pointed star.

6. The identification tag of claim 1, wherein the thickness of the body corresponds substantially to the thickness of the device.

7. The identification tag of claim 1, wherein the device includes at least one Radio Frequency Identification (RFID) chip.

8. The identification tag of claim 1, wherein at least one side of the body includes an area configured for accommodating indicia applied to the tag by techniques selected from the group consisting of printing and etching.

9. The identification tag of claim 1, wherein the adhesive material includes an insulating material that permits the transmission of electronic signals therethrough.

10. The identification tag of claim 1, wherein the spacer material includes a resin.

11. An identification tag comprising:
a metal body including oppositely disposed first and second sides;
an aperture in the body, extending through the body, the aperture including at least one inner edge; and
a device responsive to electronic signals within the aperture and positioned in the aperture by an adhesive material that fixes the device in position in the aperture and maintains the device from contacting the at least one inner edge of the aperture, and the thickness of the device corresponds substantially to the thickness of the body.

12. The identification tag of claim 11, wherein the device is positioned in the aperture to be accessible to electronic signals on the oppositely disposed first and second sides of the body.

13. The identification tag of claim 11, wherein the metal body includes sheet metal.

14. The identification tag of claim 11, wherein the aperture is of a circular shape and the at least one inner edge includes a single edge.

15. The identification tag of claim 11, wherein the aperture is of a star-like shape and the at least one inner edge includes a plurality of inner edges corresponding to the segments defining the star-like shape.

16. The identification tag of claim 15, wherein the star-like shape includes a twelve pointed star.

17. The identification tag of claim 12, wherein the device includes at least one Radio Frequency Identification (RFID) chip.

18. The identification tag of claim 11, wherein at least one side of the body includes an area configured for accommodating indicia applied to the tag by techniques selected from the group consisting of printing and etching.

19. The identification tag of claim 11, wherein the adhesive material includes an insulating material that permits the transmission of electronic signals therethrough.

20. The identification tag of claim 11, wherein the adhesive material includes a resin.

21. A method for making an identification tag comprising:
providing at least one metal body with oppositely disposed upper and lower surfaces:
making an aperture in the at least one metal body, the aperture extending through the at least one metal body;
placing a device responsive to electronic signals within the aperture;
maintaining the device so as to be substantially coplanar with the upper and lower surfaces; and,
filling the aperture with material that allows for the passage of electronic signals therethrough to fasten the device in place such that the device is out of contact with the edges of the aperture and that the device is accessible to electronic signals on both sides of the at least one metal body.

22. The method of claim 21, additionally comprising, providing a backing over at least one surface of the metal body and maintaining the device so as to be substantially coplanar with the upper and lower surfaces includes placing the device within the aperture over the backing.

23. The method of claim 22, additionally comprising removing the backing.

24. The method of claim 21, wherein providing the at least one metal body includes providing a metal sheet for accommodating the at least one metal body.

25. The method of claim 24, wherein the at least one metal body includes a plurality of metal bodies.

26. The method of claim 21, wherein making an aperture includes cutting a star-shaped aperture in the at least one metal body.

27. The method of claim 26, wherein the star-shaped aperture is a twelve pointed star shape.

28. The method of claim 21, wherein the device includes a radio frequency identification chip.

29. The method of claim 21, wherein filling the aperture with a material includes filling the aperture with an adhesive material.

30. The method of claim 29, wherein the material includes a resin.

30. The method of claim 29, wherein the resin is an ultraviolet curable resin and the method additionally includes curing the resin to harden and fix the device in place.
